(19) United States
(12) Patent Application Publication
(10) Pub. No.: US 2013/0321621 A1
(43) Pub. Date: Dec. 5, 2013

(54) Method for Mapping Hidden Objects Using Sensor Data

(71) Applicant: Martin M. Menzel, San Jose, CA (US)

(72) Inventor: Martin M. Menzel, San Jose, CA (US)

(21) Appl. No.: 13/485,881

(22) Filed: May 31, 2012

(51) Int. Cl. H04N 7/18

(52) U.S. Cl. 348/142; 348/E07.085

(57) ABSTRACT

An electronic device with an image sensor may capture an image of the surface of a structure as a user moves the device across the surface of the structure. The electronic device may have sensors such as a magnetometer, an acoustic sensor, and a thermal sensor for gathering sensor data. An accelerometer and a gyroscope within the electronic device may be used in gathering position information. The image may be captured by gathering image tiles and stitching together the image tiles to form the image. An object such as a ferromagnetic object may be embedded within the structure below the surface. The electronic device may have a display on which the image is displayed. Information about the location of the object which is gathered using the sensors may be overlaid on top of the displayed image.

### BACKGROUND

This relates generally to electronic devices and, more particularly, to using sensors in electronic devices to map hidden objects.

It is often desirable to be able to detect objects that are hidden from view. In fields such as the construction industry, for example, it is often desirable to be able to locate pipes and other objects that are hidden behind a wall. If care is not taken, the failure to recognize hidden objects may lead to damage. For example, a worker who is not informed of the location of a pipe may inadvertently cause damage to the pipe when drilling a hole in a wall.

It would therefore be desirable to be able to provide improved ways in which to identify the location of hidden objects using an electronic device.

### SUMMARY

An electronic device may be provided with an image sensor for capturing an image of the surface of a structure as a user moves the electronic device across the surface of the structure. The electronic device may be a handheld electronic device. The user may sweep the device over an area of the surface that is of interest to the user. While sweeping the device over the area of interest, an accelerometer and a gyroscope within the device may be used to gather real-time position information.

The electronic device may have sensors such as a magnetometer, an acoustic sensor, and a thermal sensor for gathering sensor data as the user moves the electronic device across the surface of the structure. The accelerometer and a gyroscope within the electronic device may be used in gathering position information specifying the location of the electronic device as the electronic device is moved across the surface to capture the image of the surface and to gather the sensor data.

An image of the surface may be captured by gathering image tiles and stitching together the image tiles to form the image. An object such as a ferromagnetic object may be embedded within the structure below the surface. The electronic device may have a display on which the image is displayed. Information about the location of the object which is gathered using the sensors may be overlaid on top of the displayed image. Annotation information such as tags describing the nature of the object may also be displayed.

Further features of the invention, its nature and various advantages will be more apparent from the accompanying drawings and the following detailed description of the preferred embodiments.

### BRIEF DESCRIPTION OF THE DRAWINGS

FIG. 1 is a perspective view of an illustrative electronic device with hidden object sensing and mapping capabilities in accordance with an embodiment of the present invention.

FIG. 2 is a schematic diagram of an electronic device of the type shown in FIG. 1 in accordance with an embodiment of the present invention.

FIG. 3 is a diagram showing how an image of a wall or other structure may be constructed from a series of overlapping image tiles in accordance with an embodiment of the present invention.

FIG. 4 is a graph showing how a sensor signal that is gathered by an electronic device may vary as a function of device position in accordance with an embodiment of the present invention.

FIG. 5 is a diagram showing how an image sensor may capture image tiles in accordance with an embodiment of the present invention.

FIG. 6 is a diagram showing how a sensor such as a magnetometer may be used to gather information on the location of potentially hidden ferromagnetic objects in accordance with an embodiment of the present invention.

FIG. 7 is a diagram showing how sensors such as a microphone, accelerometer, and temperature sensor may be used in gathering information on potentially hidden object in accordance with an embodiment of the present invention.

FIG. 8 is an illustrative display screen containing a visual representation of the location of objects that have been detected using sensor circuitry in accordance with an embodiment of the present invention.

FIG. 9 is an illustrative display screen containing a reconstructed image of a structure that has been annotated with the locations and types of objects that have been detected using sensor circuitry in accordance with an embodiment of the present invention.

FIG. 10 is a flow chart of illustrative steps involved in using captured images and sensor data to provide a user with information on hidden objects in accordance with an embodiment of the present invention.

### DETAILED DESCRIPTION

An electronic device may be provided with an image sensor. A user may use the image sensor to capture an image of the user's environment. For example, the user may scan a portable electronic device across a surface such as the wall of a building while using the image sensor to acquire image data. Sensors within the electronic device may monitor the location and orientation of the device. Using information on the position of the device, the image data may be used to produce an image of the surface.

While capturing information on the appearance of the surface using the image sensor, sensors within the electronic device such as a magnetometer and other sensors may capture information on the location and type of potentially hidden features within the wall. The electronic device may process the sensor data to annotate the image of the surface with the locations of ferromagnetic objects such as pipes and other objects detected by the sensors (runs of heating and air conditioning conduit, wall studs, wiring, etc.).

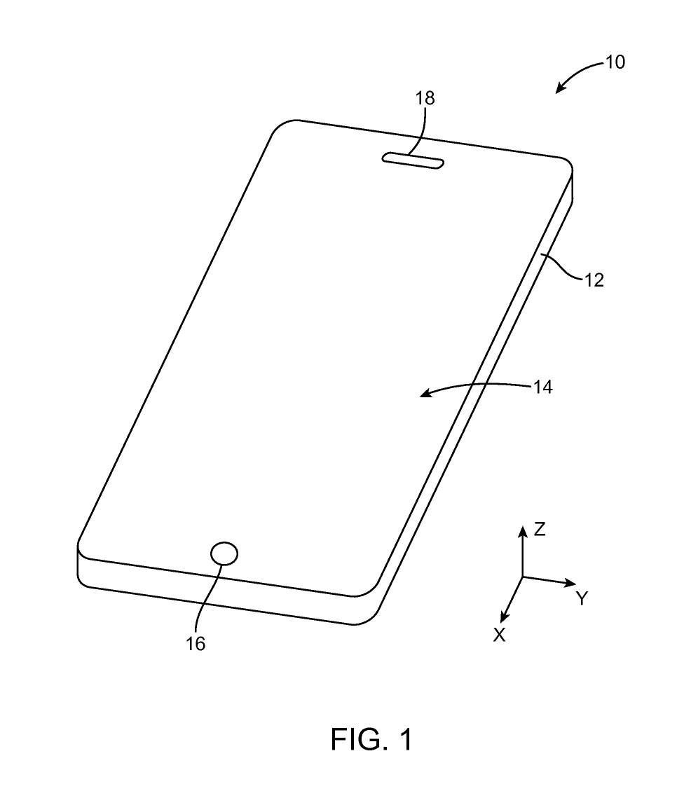

An illustrative electronic device of the type that may be provided with sensing capabilities for locating potentially hidden objects within a wall or other structure is shown in FIG. 1. Electronic device 10 may be a computer such as a computer that is integrated into a display such as a computer monitor, a laptop computer, a tablet computer, a somewhat smaller portable device such as a wrist-watch device, pendant device, or other wearable or miniature device, a handheld device such as a cellular telephone, a media player, a tablet computer, a gaming device, a navigation device, a computer monitor, a television, or other electronic equipment.

As shown in FIG. 1, device 10 may include a display such as display 14. Display 14 may be a touch screen that incorporates a layer of conductive capacitive touch sensor electrodes or other touch sensor components or may be a display that is not touch-sensitive. Display 14 may include an array of display pixels formed from liquid crystal display (LCD) components, an array of electrophoretic display pixels, an array of plasma display pixels, an array of organic light-emitting diode display pixels, an array of electrowetting display pixels, or display pixels based on other display technologies. Configurations in which display 14 includes display layers that form liquid crystal display (LCD) pixels may sometimes be described herein as an example. This is, however, merely illustrative. Display 14 may include display pixels formed using any suitable type of display technology.

Display 14 may be protected using a display cover layer such as a layer of transparent glass or clear plastic. Openings may be formed in the display cover layer. For example, an opening may be formed in the display cover layer to accommodate a button such as button 16. An opening may also be formed in the display cover layer to accommodate ports such as speaker port 18.

Device 10 may have a housing such as housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials.

Housing 12 may be formed using a unibody configuration in which some or all of housing 12 is machined or molded as a single structure or may be formed using multiple structures (e.g., an internal frame structure, one or more structures that form exterior housing surfaces, etc.). The periphery of housing 12 may, if desired, include walls. For example, housing 12 may have a peripheral conductive member such as a metal housing sidewall member that runs around some or all of the periphery of device 10 or may have a display bezel that surrounds display 14. Housing 12 may have sidewalls that are curved, sidewalls that are planar, sidewalls that have a combination of curved and flat sections, and sidewalls of other suitable shapes. One or more openings may be formed in housing 12 to accommodate connector ports, buttons, and other components.

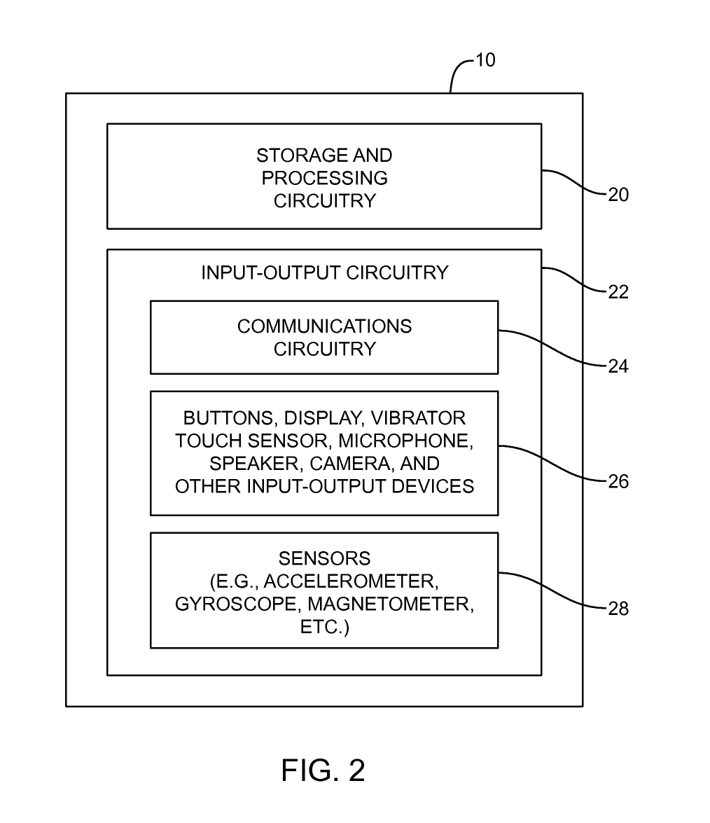

A schematic diagram of device 10 showing how device 10 may include sensors and other components is shown in FIG. 2. As shown in FIG. 2, electronic device 10 may include control circuitry such as storage and processing circuitry 20. Storage and processing circuitry 20 may include one or more different types of storage such as hard disk drive storage, nonvolatile memory (e.g., flash memory or other electrically-programmable-read-only memory), volatile memory (e.g., static or dynamic random-access-memory), etc. Processing circuitry in storage and processing circuitry 20 may be used in controlling the operation of device 10. The processing circuitry may be based on a processor such as a microprocessor and other suitable integrated circuits. With one suitable arrangement, storage and processing circuitry 20 may be used to run software on device 10, such as internet browsing applications, email applications, media playback applications, operating system functions, software for capturing and processing images, software implementing functions associated with gathering and processing sensor data, software that simultaneously displays images and annotation data to a user, etc.

Input-output circuitry 22 may be used to allow data to be supplied to device 10 and to allow data to be provided from device 10 to external devices.

Input-output circuitry 22 may include wired and wireless communications circuitry 24. Communications circuitry 24 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications).

Input-output circuitry 22 may also include buttons such as button 16 of FIG. 1, joysticks, click wheels, scrolling wheels, a touch screen such as display 14 of FIG. 1, other touch sensors such as track pads or touch-sensor-based buttons, vibrators, audio components such as microphones and speakers, image capture devices such as a camera module having an image sensor and a corresponding lens system, keyboards, status-indicator lights, tone generators, key pads, and other equipment for gathering input from a user or other external source and/or generating output for a user.

Sensor circuitry such as sensors 28 of FIG. 2 may include an ambient light sensor for gathering information on ambient light levels, a capacitive proximity sensor, an infrared-light-based proximity sensor, a proximity sensor based on acoustic signaling schemes, or other proximity sensors, a light sensor, a capacitive sensor for use as a touch sensor array, a pressure sensor, a temperature sensor, an accelerometer, a gyroscope, a magnetometer, or other circuitry for making measurements of the environment surrounding device 10.

An accelerometer may be used in device 10 to monitor the position of device 10. The accelerometer may be based on a microelectromechanical systems (MEMS) device or other suitable mechanism. The accelerometer may be sensitive to orientation. For example, the accelerometer may be a three-axis accelerometer that contains three orthogonal accelerometer structures. The output of this type of accelerometer may depend on the orientation of device 10 relative to the Earth. When a user adjusts the orientation of device 10 relative to the Earth, the new direction in which device 10 is pulled towards the Earth by gravity may be detected. Movement of device 10 relative to the Earth may also produce measurable accelerometer signals (e.g., acceleration data associated with device movement). The use of an accelerometer in device 10 may therefore allow device 10 to track the location and orientation of device 10 in real time. Maintaining information on the position of device 10 (e.g., to determine the location of device 10 in three dimensions and to determine the angular orientation of device 10) allows device 10 to make sensor measurements and other measurements as a function of the known position of device 10.

The position of device 10 (e.g., the angular orientation of device 10) may also be measured using a gyroscope. Gyroscopes are generally more sensitive to changes in angular orientation than accelerometers. By using both a gyroscope and an accelerometer (and, if desired, additional sensors), the location of device 10 in orthogonal dimensions X, Y, and Z and the angular orientation of device 10 may be determined in real time with enhanced accuracy.

By monitoring the position (location and orientation) of device 10 in real time, images of the current environment for device 10 that are simultaneously captured can be correlated with location information. A user may therefore move device 10 over a wall or other surface while simultaneously using device 10 (i.e., a camera in device 10) to capture images of the surface. As each image is captured, the location of that image can be retained in storage and processing circuitry 20.

Sensor data can also be simultaneously acquired by device 10 during movement of device 10 over the surface of a wall or throughout other environments. Following movement of device 10 over all areas of interest (e.g., after completely mapping all desired portions of a wall or other surface), the sensor data can be overlaid on top of the image data (e.g., on a display such as display 14 of FIG. 1).

The sensor data may include information from sensors 28 and/or input-output devices 26. The sensor data may, for example, include audio data measured using a microphone, vibration data from an accelerometer, temperature data from a temperature sensor, and magnetic data from a magnetometer.

A magnetometer (sometimes referred to as a compass) measures magnetic field strength and may therefore be used to detect the presence of magnetic signal sources and/or ferromagnetic materials or other structures that affect the distribution of magnetic fields within the environment. As an example, magnetometer readings by device 10 may be used to detect the presence of ferromagnetic items such as pipes within a wall or other structure.

The detection of temperature variations may be used to discriminate between hot pipes and cold pipes. Temperature data can also be used to identify the location of heating vents and other items that produce heat.

Vibration data measured using a microphone and/or an accelerometer may be used to detect the presence of vibrating equipment such as a ventilation conduit or a fan. Vibration data may also be used in locating studs (e.g., 2×4 lumber or other framing members) within a wall. In the absence of a stud, sheetrock on a wall may have one set of vibration characteristics (i.e., the wall may be characterized by a lower resonance frequency). In the vicinity of a stud, the sheetrock may exhibit a higher resonance frequency. A vibrator in device 10 may be used to generate acoustic signals. When device 10 is placed on the surface of a wall, these signals may be launched into the wall. A microphone or accelerometer may then be used to measure corresponding acoustic signals indicating whether device 10 is or is not located directly over a stud in the wall.

After capturing an image of a wall or other structure and after making sensor measurements to identify features that are associated with the wall or other structure such as buried studs and pipes and other potentially hidden objects within the wall or other structure, device 10 may be used to produce an annotated image of the wall or other structure. The image may contain a picture of the surface of the wall or other structure that has been reconstructed from one or more individual image tiles. Annotations in the image may include schematic representations of detected objects (e.g., schematic representations of pipes, studs, etc.). Annotations in the image may also include raw data (e.g., magnetic field magnitude data from a magnetometer, etc.) that is overlaid on top of the image. Labels (e.g., “hot pipe”) may also be overlaid on top of the image, if desired. The annotated image may be displayed on display 14 of device 10 and/or may be transmitted to external equipment (e.g., using circuitry 24 of FIG. 2) for display using the external equipment.

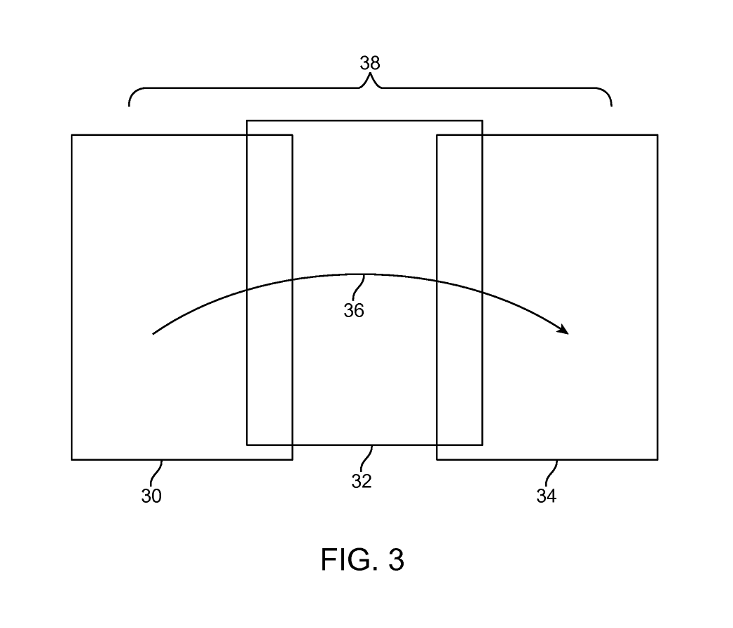

FIG. 3 is a diagram showing how an image may be constructed from multiple image tiles. As shown in FIG. 3, a user may move device 10 over the surface of an object to capture multiple images such as images 30, 32, and 34 (sometimes referred to as image tiles). The user may, for example, move device 10 along path 36 while storage and processing circuitry 20 uses a camera to capture each image tile. As each image tile is captured, device 10 may simultaneously record the position of device 10. Subsequently, device 10 can process the image data that has been acquired to form a final image. As an example, overlapping image tiles 30, 32, and 34 may be combined to form a single composite image such as image 38 of FIG. 3. Image 38 may include portions of each image tile that have been stitched together using the processing circuitry of device 10. The stitching process may involve image processing operations that recognize common features of overlapping tiles and/or may use the position information gathered during image tile acquisition operations.

Device 10 may be held at any suitable distance from the surface of a wall or other structure that is being imaged. As an example, device 10 may be held at a distance of about 1-10 inches, less than 10 inches, more than 5 inches, or other suitable distance from the surface of a wall or other structure as the user moves device 10 back and forwards in a sweeping motion, effectively scanning the entire surface of interest with device 10. Small distances may enhance the ability of device 10 to capture data such as temperature data, but may reduce or eliminate the ability of device 10 to capture an image of the surface of the wall. Larger distances may facilitate image capture, but may make temperature readings more difficult to acquire.

While scanning the surface of interest with device 10, device 10 can capture images using a camera in device 10 and can store captured image data and simultaneously gathered position information in storage for subsequent processing. If desired, device 10 may be scanned across the surface of a wall or other structure of interest while pressing device 10 against the surface of the wall (i.e., while spacing device 10 closely to the wall). In this type of situation, device 10 may be so close to the surface of the wall that the picture taking process may be suspended. In other scenarios, device 10 may acquire image data for a wall or other surface while the user holds device 10 at a relatively large distance from the wall (e.g., 10 inches or more). In this type of scenario, it may be acceptable to capture fewer image tiles, because a relatively large amount of the surface area of the image may be captured in each tile.

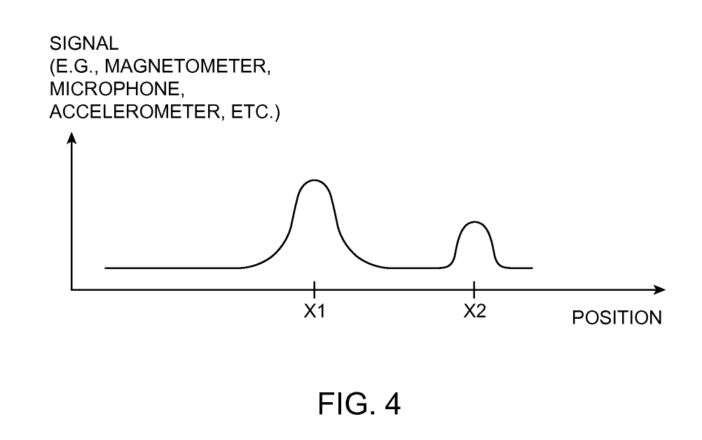

While a user is scanning device 10 in a pattern that covers the surface of a wall or other structure, device 10 may store sensor data using control circuitry 20. FIG. 4 is a graph showing how sensor data signals may vary as a function of device position (e.g., the lateral position of across the surface of interest). In the FIG. 4 example, the sensor signal had peaked at two different locations on the surface: position X1 and position X2. The sensor signal that is being measured may be an acoustic signal, a thermal signal, an electromagnetic signal (e.g., a radio-frequency signal), a light signal, a magnetic signal, or combinations of two or more of these signals (as examples). The sensor signal that is plotted in the graph of FIG. 4 may, for example, be a magnetometer signal indicative of the presence of two ferromagnetic objects, the first of which is located at position X1 and the second of which is located at position X2. As another example, the sensor signals of the graph of FIG. 4 may represent acoustic signals indicating the presence of a wall stud at location X1 and a wall stud at location X2. Sensor data may, if desired, be gathered from more than one sensor at a time. For example, device 10 may simultaneously gather temperature data, acoustic signal data, image data, magnetometer data, and other data.

The measurements that are made by device 10 may reveal surface details (visible features) and/or may reveal information about buried or otherwise hidden objects within a wall or other structure. The processed image and sensor data that is created to present detected objects to a user may contain surface data (e.g., captured images) and/or may contain data for hidden objects (e.g., a pipe or other structure that is hidden within a wall or other structure).

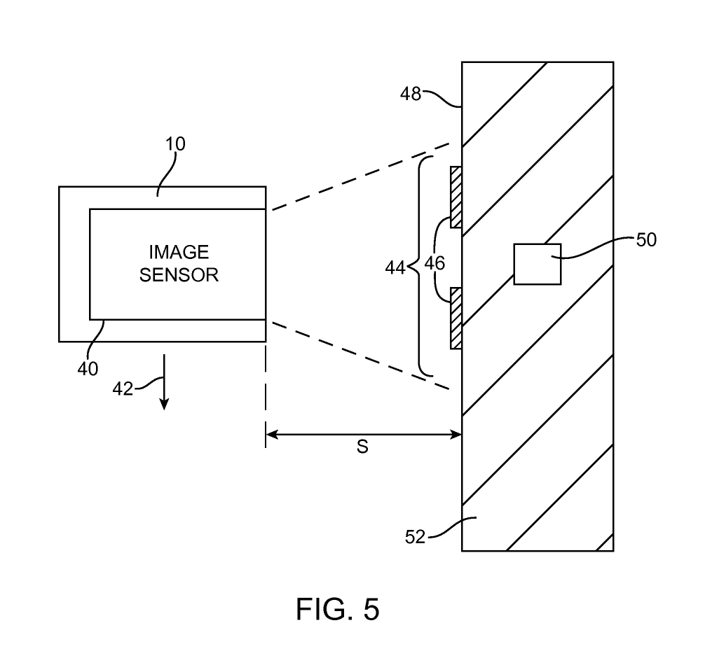

FIG. 5 shows how device 10 may contain an image sensor such as image sensor 40. Image sensor 40 may be contained within a camera module or other component within input-output device 26 of FIG. 2. A user may be interested in capturing an image of surface 48 of structures 52. Structures 52 may include a wall of a building or other structures. Objects such as object 50 may be hidden within structures 52 and may therefore not be visible to camera 40 of device 10. Camera 40 may, however, capture images of surface 48 of structures 52. As an example, camera 40 may capture image 44 containing surface features 46 on surface 48 of structures 52.

Surface features 46 may include protruding features and non-protruding features. Protruding features may include features such as drywall texturing, nail heads, screw heads, other structures that are mounted, attached, or coated on surface 48, surface roughness on surface 48 or other textures or protrusions that are associated with materials that make up structures 52. Non-protruding features may include features such as colors, color patterns, or surface roughness patterns associated with materials that are coated on surface 48 (e.g., paint, lacquer, etc.) or with material materials that make up structures 52 (e.g., wood grains in a wooden wall).

Surface features 46 in image 44 may be used to map surface features on structures 52 for display for a user or may be used to determine properties of structures 52 such as identifying a material that makes up structures 52 (e.g., determining whether a wall is made of wood or sheetrock or determining whether a floor surface is a dirt surface, a grassy surface, a concrete surface, a wooden surface, or a tile surface).

It may be desirable for a user to scan device 10 across the portions of surface 48 that are of interest to the user. For example, a user may move device 10 laterally in direction 42, while maintaining a desired spacing S between device 10 and surface 48. As device 10 is moved, device 10 may capture image tiles covering all portions of surface 48 that are of interest to the user.

Structures 52 may contain embedded objects such as object 50. In scenarios in which structures 52 form a wall within a building, for example, object 50 may be a piece of lumber such as a wall stud, a metal beam, a pipe, wiring, ventilation conduit, a fan, a nail, a screw, or other items that may be embedded within a wall. In other types of environments (e.g., outdoors), objects such as object 50 may be natural or manmade objects (e.g., a rock buried in the ground, a piece of iron in the ground, etc.). When structures 52 are opaque, surface 48 may be viewed by image sensor 40, but objects such as object 50 will be hidden within structures 52.

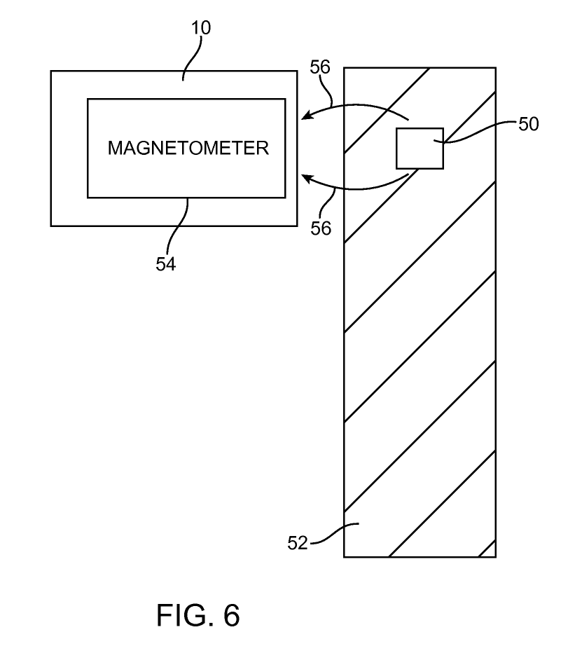

To detect the presence of embedded object 50, device 10 may use a sensor that is capable of receiving signals through structures 52, such as magnetometer 54 of FIG. 6. As shown in FIG. 6, magnetometer 54 may measure magnetic signals 56 that are produced by and/or influenced by the presence of object 50 within structures 52. By analyzing magnetic signals 56 and associated position data from an accelerometer and/or gyroscope, device 10 can identify that object 50 is present within structures 52 and can identify the location of object 50 within structures 52.

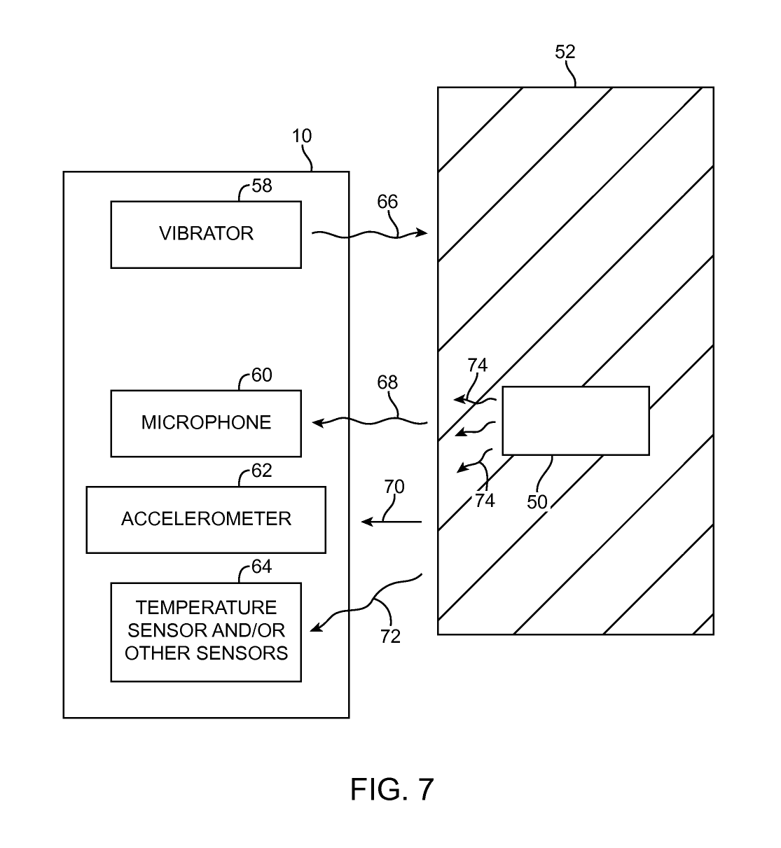

FIG. 7 shows how a device 10 may produce audio signals (ultrasonic or in an audible range) such as audio signals 66 using vibrator (transducer) 58. Vibrator 58 may include an unbalanced rotating weight or may be implemented using a speaker, buzzer, or other device that produces audio signals in device 10.

Due to the presence of audio signals 66 or due to independently produced audio signals (vibrations) such as sound 74, audio signals (vibrations) may be detected by device 10, as illustrated by the detection of vibrations (sound) 68 by microphone 60 and the detection of vibrations (sound) 70 by accelerometer 62. An audio-based (i.e., vibration-based) system such as the system of FIG. 7 may allow device 10 to detect the presence of objects such as object 50 that potentially do not have ferromagnetic material (e.g., plastic pipes, wall studs, etc.).

If desired, additional sensor measurements may be made using device 10. For example, temperature sensor 64 may be used to measure heat 72 from structures 52 and object 50. The amount of heat that is produced in the vicinity of object 50 may be used to identify object 50. If, for example, a magnetometer (FIG. 6) in device 10 detects the presence of an iron pipe in structures 52, temperature sensor 64 may be used to measure the temperature of the pipe to determine whether the pipe is carrying hot or cold water. Device 10 may then annotate the image of surface 48 accordingly (e.g., with the label “hot pipe” if the pipe is determined to be carrying hot water or “cold pipe” if the pipe is being determined).

In some situations, image data such as image 44 of FIG. 5 may be combined with sensor data (magnetic signal magnitude, temperature, acoustic signal magnitude and/or frequency, or other sensor data) by device 10 in interpreting the sensor data. For example, because different materials such as wood and sheetrock conduct heat differently, temperature sensor data may be interpreted differently based on a detection of a wooden wall or a sheetrock wall in image 44.

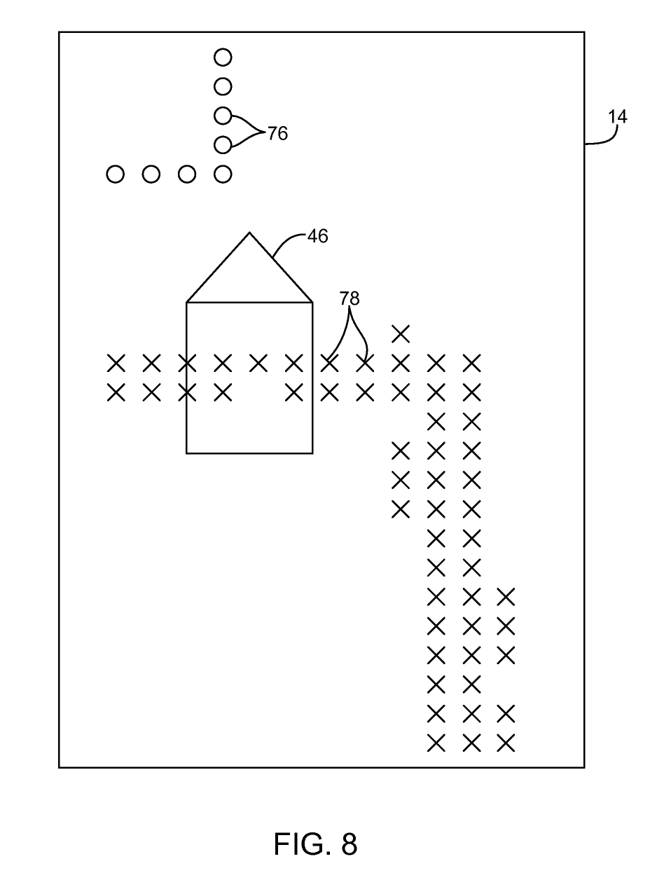

Sensor data (magnetic signal magnitude, temperature, acoustic signal magnitude and/or frequency, or other sensor data) may be plotted as an overlay on top of a captured image (e.g., on top of an image formed by stitching together multiple image tiles). FIG. 8 shows how sensor data such as sensor data 76 and 78 may be displayed on display 14 of device 10. Surface features on surface 48 of structures 52 that have been imaged by the camera in device 10 may be displayed as part of the reconstructed image that is displayed on screen 14 (see, e.g., item 46 in FIG. 8). Sensor data such as sensor data 76 and 78 may be overlaid on top of captured image data 46, as shown in FIG. 8. Image data 76 and 78 may use different types of symbols to represent different sensor signal intensities and/or different types of sensor data. For example, sensor data 76 may correspond to a ferromagnetic signal from a magnetometer and may therefore be represented using a first type of symbol (e.g., the “◯” character), whereas sensor data 78 may correspond to acoustic signals representing an embedded piece of lumber and may therefore be represented by a second type of symbol (e.g., the “×” character).

Different types of characters may represent different corresponding features (e.g., one character may be used to identify pipes, whereas another type of character may be used to identify wall studs) or different characters or other symbols may be used to represent different signal strengths (e.g., different magnetometer signal strengths) or combinations of detected signals. As an example, a character may be used to represent hot ferromagnetic features (i.e., features with more than a predetermined temperature), whereas a different character may be used to represent cold ferromagnetic features. In general, the visual elements used for representing information on display 14 may include identifying colors, identifying shapes, identifying intensities, or other information for representing embedded features.

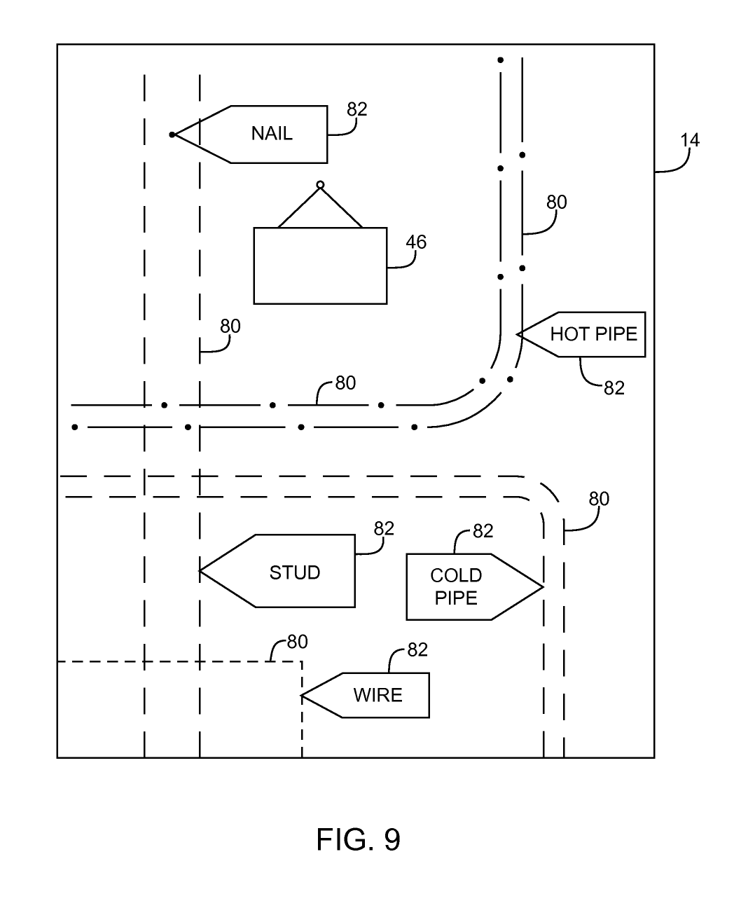

FIG. 9 shows how items on display 14 may be annotated using text labels. The image on display 14 may include image data such as surface feature 46 from image tiles that have been stitched together by device 10. Surface features such as surface feature 46 may form a picture (e.g., a color or monochrome picture) of surface 48 of structures 52. Sensor data 80 may be overlaid on top of the image of surface 48. Sensor data 80 may include symbols or other visual elements that define the locations of detected items (e.g., ferromagnetic features detected using a magnetometer such as pipes, nails, or wires, other features such as wall studs and other non-ferromagnetic features detected using vibrations, and other potentially hidden items). If desired, the annotations made using visual elements 80 may be provided with text label annotations such as labels 82.

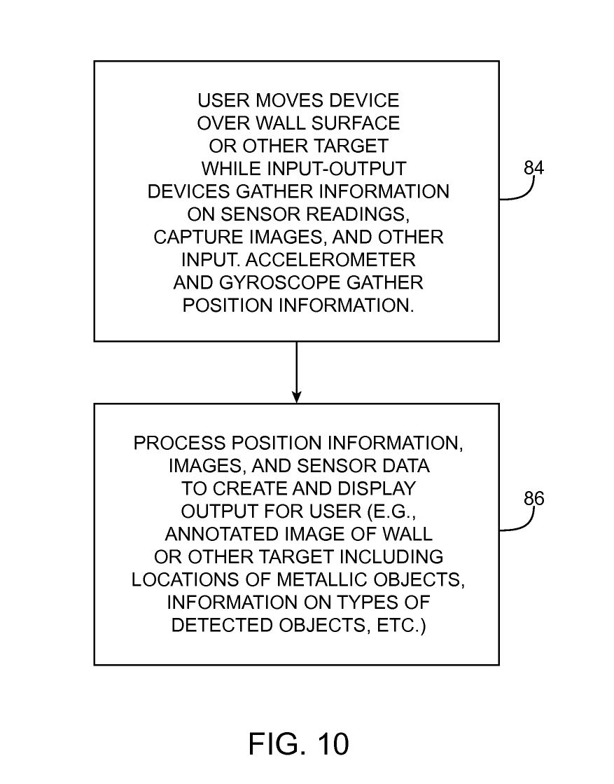

Illustrative steps involved in using an electronic device such as device 10 to capture an image of the surface of a structure while using sensors to gather information on objects embedded within the structure are shown in FIG. 10.

At step 84, a user may move device 10 across surface 48 of structures 52 or may otherwise manipulate the position of device 10 so as to capture images and sensor data of interest. A user may, for example, scan device 10 across an area of interest using a sweeping back-and-forth motion until image tiles that cover the entire swept area and corresponding sensor readings have been gathered. Images tile data may be stored in device 10 with corresponding sensor data from sensors such from components such as a thermal sensor, acoustic sensor (e.g., a microphone or accelerometer), a magnetometer for detecting magnetic signals, or other sensors. While image tile data and sensor data is being gathered by device 10, device 10 may gather data on the position of device 10 in real time. Device 10 may, for example, use an accelerometer and/or a gyroscope to measure the position of device 10 as each image tile is captured and corresponding sensor reading is made.

At step 86, the image tile data that was collected during the operations of step 84 may be stitched together to form an image of an area of interest (i.e., surface 48 of structures 52). Information on the position of device 10 during the acquisition of each image tile may be used in stitching together the image tiles. The process of stitching together the image data forms a visual map of the surface of structures 52. The locations of surface features such as features 46 may be identified by viewing the completed image. Device 10 may also process the sensor data that was collected. In particular, device 10 may, during the operations of step 86, process the sensor data and device position data to identify the locations and potentially the types of embedded objects such as embedded object 50. Device 10 may, as an example, identify ferromagnetic structures using magnetometer data, may identify non-ferromagnetic structures using acoustic data, and may use additional data such as thermal data and other data to provide additional information about embedded objects.

The foregoing is merely illustrative of the principles of this invention and various modifications can be made by those skilled in the art without departing from the scope and spirit of the invention. The foregoing embodiments may be implemented individually or in any combination.

What is claimed is:

1. A method, comprising:
with an image sensor in an electronic device, capturing an image of a surface of a structure that contains an embedded object that is hidden below the surface;
with a sensor in the electronic device, gathering sensor data on the embedded object as a user moves the electronic device across the surface of the structure; and
gathering position information for the electronic device while capturing the image of the surface of the structures and while gathering the sensor data.

2. The method defined in claim 1 wherein capturing the image comprises:
capturing a plurality of overlapping image tiles using the image sensor as the user moves the electronic device across the surface of the structure.

3. The method defined in claim 1 wherein the sensor comprises an acoustic sensor and wherein gathering the sensor data comprises gathering acoustic data using the acoustic sensor.

4. The method defined in claim 1 wherein the sensor comprises a temperature sensor and wherein gathering the sensor data comprises gathering temperature data using the temperature sensor.

5. The method defined in claim 1 wherein the sensor comprises a magnetometer and wherein gathering the sensor data comprises gathering magnetometer data using the magnetometer.

6. The method defined in claim 5 further comprising:
using a temperature sensor in the electronic device to gather temperature data while gathering the magnetometer data using the magnetometer.

7. The method defined in claim 1 further comprising:
using the image, the gathered sensor data, and the gathered position information to display sensor information about the embedded object on a display of the electronic device, wherein the sensor information about the embedded object is overlaid on top of the image.

8. The method defined in claim 7 wherein the object comprises a ferromagnetic object, wherein the sensor comprises a magnetometer, and wherein gathering the sensor data comprises measuring magnetic signals associated with ferromagnetic object using the magnetometer.

9. The method defined in claim 8 wherein capturing the image comprises:
capturing a plurality of image tiles using the image sensor as the user moves the electronic device across the surface of the structure; and
stitching together the image tiles to form the image.

10. The method defined in claim 7 further comprising:
displaying at least one text label on the image to identify the sensor data.

11. A method of mapping the location of a ferromagnetic object that is hidden by a surface of a structure, comprising:
while a handheld electronic device is moved over the surface, capturing image data for an image using an image sensor in the handheld electronic device;
with a magnetometer in the handheld electronic device, gathering magnetometer data associated with the ferromagnetic object; and
displaying at least some of the magnetometer data overlaid on the image.

12. The method defined in claim 11 wherein the handheld electronic device includes a display and wherein displaying the magnetometer data overlaid on the image comprises displaying the image and the magnetometer data on the display.

13. The method defined in claim 12 wherein the image data for the image includes multiple image tiles, the method further comprising using the multiple image tiles in forming the image on the display.

14. The method defined in claim 13 wherein using the multiple image tiles comprises stitching together the image tiles using control circuitry in the handheld electronic device.

15. The method defined in claim 14 wherein the surface comprises a wall surface and wherein displaying the magnetometer data overlaid on the image comprises displaying information representing a pipe over the wall surface.

16. The method defined in claim 15 wherein the electronic device includes an accelerometer and a gyroscope, the method further comprising gathering current position information for the handheld electronic device using the accelerometer and the gyroscope while the handheld electronic device is moved over the surface.

17. An electronic device, comprising:
a magnetometer configured to gather magnetometer data from an object embedded behind a surface; and
an image sensor configured to capture an image of the surface while the magnetometer is being used to gather the magnetometer data.

18. The electronic device defined in claim 17 further comprising:
an accelerometer configured to gather position information for the electronic device as the magnetometer gathers the magnetometer data.

19. The electronic device defined in claim 18 further comprising:
a gyroscope configured to gather position information for the electronic device as the magnetometer gathers the magnetometer data.

20. The electronic device defined in claim 19 wherein the image sensor is configured to capture the image by capturing a plurality of overlapping image tiles, the electronic device further comprising:
control circuitry configured to stitch together the overlapping image tiles to form the image; and
a display configured to display the image and a representation of the object on the image.
